(19) United States
(12) Patent Application Publication
(10) Pub. No.: US 2024/0020574 A1
(43) Pub. Date: Jan. 18, 2024

(54) INFORMATION PROCESSING APPARATUS, INFORMATION PROCESSING METHOD, AND COMPUTER PROGRAM

(71) Applicant: NEC Corporation, Minato-ku, Tokyo (JP)

(72) Inventors: Akinori EBIHARA, Tokyo (JP); Talkl MYAGAWA, Tokyo (JP)

(73) Assignee: NEC Corporation, Minato-ku, Tokyo (JP)

(21) Appl. No.: 18/037,158

(22) PCT Filed: Nov. 24, 2020
(86) PCT No.: PCT/JP2020/043625

§ 371 Date: May 16, 2023

(51) Int. Cl. G06N 20/00

(52) U.S. Cl. CPC G06N 20/00

(57) ABSTRACT

An information processing apparatus includes: an acquisition unit that obtains a plurality of elements included in series data; a calculation unit that calculates a classification index indicating a likelihood of a class to which the series data belong, on the basis of at least two elements of the plurality of elements; and a selection unit that selects and outputs, from N classes that are classification candidates of the series data (where N is a natural number), K classes to which the series data are likely to belong (where K is a natural number that is less than or equal to N and that is greater than or equal to 1), on the basis of the classification index. According to the information processing apparatus, it is possible to select a plurality of classes to which the series data are likely to belong.

### TECHNICAL FIELD

This disclosure relates to an information processing apparatus, an information processing method, and a computer program that process information about classification, for example.

### BACKGROUND ART

A known apparatus of this type classifies input data. For example, Patent Literature 1 discloses a technique/technology of outputting a plurality of class candidates on the basis of a classification score.

As another related technique/technology, for example, Patent Literature 2 discloses a technique/technology of pruning a candidate with a lower posteriori probability than a threshold, of authentication target candidates.

### CITATION LIST

### Patent Literature

Patent Literature 1: JP2013-025496A
Patent Literature 2: JP2009-289253A

### SUMMARY

### Technical Problem

This disclosure aims to improve the related techniques/technologies described above.

### Solution to Problem

An information processing apparatus according to an example aspect of this disclosure includes: an acquisition unit that obtains a plurality of elements included in series data; a calculation unit that calculates a classification index indicating a likelihood of a class to which the series data belong, on the basis of at least two elements of the plurality of elements; and a selection unit that selects and outputs, from N classes that are classification candidates of the series data (where N is a natural number), K classes to which the series data are likely to belong (where K is a natural number that is less than or equal to N and that is greater than or equal to 1), on the basis of the classification index.

An information processing method according to an example aspect of this disclosure obtaining a plurality of elements included in series data; calculating a classification index indicating a likelihood of a class to which the series data belong, on the basis of at least two elements of the plurality of elements; and selecting and outputting, from N classes that are classification candidates of the series data (where N is a natural number), K classes to which the series data are likely to belong (where K is a natural number that is less than or equal to N and that is greater than or equal to 1), on the basis of the classification index.

A computer program according to an example aspect of this disclosure operates a computer: to obtain a plurality of elements included in series data; to calculate a classification index indicating a likelihood of a class to which the series data belong, on the basis of at least two elements of the plurality of elements; and to select and output, from N classes that are classification candidates of the series data (where N is a natural number), K classes to which the series data are likely to belong (where K is a natural number that is less than or equal to N and that is greater than or equal to 1), on the basis of the classification index.

### BRIEF DESCRIPTION OF DRAWINGS

FIG. 1 is a block diagram illustrating a hardware configuration of an information processing apparatus according to a first example embodiment.

FIG. 2 is a block diagram illustrating a functional configuration of the information processing apparatus according to the first example embodiment.

FIG. 3 is a flowchart illustrating a flow of operation of the information processing apparatus according to the first example embodiment.

FIG. 4 is a flowchart illustrating a flow of operation of an information processing apparatus according to a second example embodiment.

FIG. 5 is a flowchart illustrating a flow of a classification index calculation process in an information processing apparatus according to a third example embodiment.

FIG. 6 is a flowchart illustrating a flow of operation of an information processing apparatus according to a fourth example embodiment.

FIG. 7 is a graph illustrating a class selection example in the information processing apparatus according to the fourth example embodiment.

FIG. 8 is a flowchart illustrating a flow of operation of an information processing apparatus according to a modified example of the fourth example embodiment.

FIG. 9 is a flowchart illustrating a flow of operation of an information processing apparatus according to a fifth example embodiment.

FIG. 10 is a graph illustrating a class selection example in the information processing apparatus according to the fifth example embodiment.

FIG. 11 is a block diagram illustrating a functional configuration of an information processing apparatus according to a sixth example embodiment.

FIG. 12 is a flowchart illustrating a flow of a classification index calculation process in the information processing apparatus according to the sixth example embodiment.

FIG. 13 is a flowchart illustrating a flow of operation of an information processing apparatus according to a seventh example embodiment.

FIG. 14 is a diagram illustrating a display example of an outputted class by the information processing apparatus according to the seventh example embodiment

FIG. 15 is a flowchart illustrating a flow of operation of an information processing apparatus according to an eighth example embodiment.

### DESCRIPTION OF EXAMPLE EMBODIMENTS

Hereinafter, an information processing apparatus, an information processing method, and a computer program according to example embodiments will be described with reference to the drawings.

### First Example Embodiment

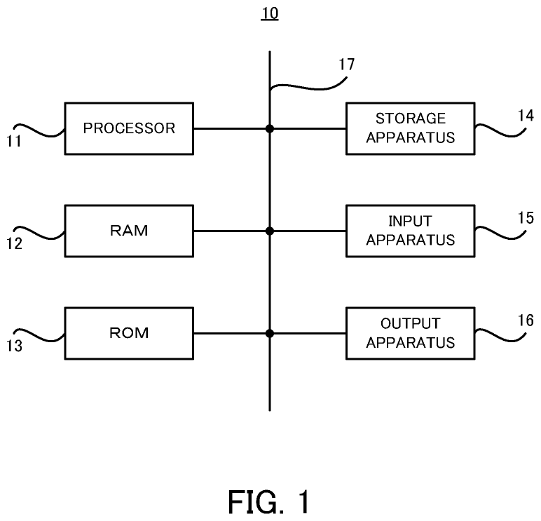

An information processing apparatus according to a first example embodiment will be described with reference to FIG. 1 to FIG. 3.

### (Hardware Configuration)

First, with reference to FIG. 1, a hardware configuration of the information processing apparatus according to the first example embodiment will be described. FIG. 1 is a block diagram illustrating the hardware configuration of the information processing apparatus according to the first example embodiment.

As illustrated in FIG. 1, an information processing apparatus 10 according to the first example embodiment includes a processor 11, a RAM (Random Access Memory) 12, a ROM (Read Only Memory)13, and a storage apparatus 14. The information processing apparatus 10 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium by using a not-illustrated recording medium reading apparatus. The processor 11 may obtain (i.e., may read) a computer program from a not-illustrated apparatus disposed outside the information processing apparatus 10, through a network interface. The processor 11 controls the RAM 12, the storage apparatus 14, the input apparatus 15, and the output apparatus 16 by executing the read computer program. Especially in this example embodiment, when the processor 11 executes the read computer program, a functional block for selecting and outputting a class to which series data may belong is realized or implemented in the processor 11. As the processor 11, one of a CPU (Central Processing Unit), a GPU (Graphics Processing Unit), a FPGA (field-programmable gate array), a DSP (Demand-Side Platform), and an ASIC (Application Specific Integrated Circuit) may be used, or a plurality of them may be used in parallel.

The RAM 12 temporarily stores the computer program to be executed by the processor 11. The RAM 12 temporarily stores the data that is temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that is stored for a long term by the information processing apparatus 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing apparatus 10. The input apparatus 15 may include, for example, at least one of a keyboard, a mouse, and a touch panel. The input apparatus 15 may be a dedicated controller (operation terminal). The input apparatus 15 may also include a terminal owned by the user (e.g., a smartphone or a tablet terminal, etc.).

The output apparatus 16 is an apparatus that outputs information about the information processing apparatus 10 to the outside. For example, the output apparatus 16 may be a display apparatus (e.g., a display) that is configured to display the information about the information processing apparatus 10. The display apparatus here may be a TV monitor, a personal computer monitor, a smartphone monitor, a tablet terminal monitor, a digital signage, or the like. The output apparatus 16 may be a speaker that outputs the information about the information processing apparatus 10 in a form of audio.

### (Functional Configuration)

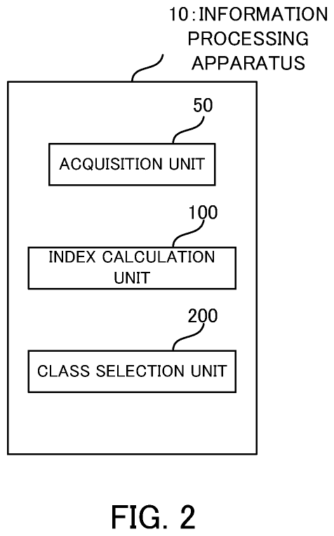

Next, a functional configuration of the information processing apparatus 10 according to the first example embodiment will be described with reference to FIG. 2. FIG. 2 is a block diagram illustrating the functional configuration of the information processing apparatus according to the first example embodiment.

As illustrated in FIG. 2, the information processing apparatus 10 according to the first example embodiment includes, as processing blocks for realizing its functions, an acquisition unit 50, an index calculation unit 100, and a class selection unit 200. Each of the acquisition unit 50, the index calculation unit 100, and the class selection unit 200 may be realized or implemented by the processor 11 (see FIG. 1).

The acquisition unit 50 is configured to obtain a plurality of elements included in the series data. The acquisition unit 50 may directly obtain data from any data acquisition apparatus (e.g., a camera or a microphone), or may read data that are obtained in advance by the data acquisition apparatus and that are stored in a storage or the like. The elements of the series data obtained by the acquisition unit 50 are configured to be outputted to the index calculation unit 100. The series data are data including a plurality of elements that are arranged in a predetermined order, and includes, for example, time series data as an example. A more specific example of the series data includes, but is not limited to, video data and audio data.

The index calculation unit 100 is configured to calculate a classification index, on the basis of at least two elements of the plurality of elements obtained by the acquisition unit 50. The index calculation unit 100 calculates the classification index, on the basis of the two elements continuously obtained in the acquisition unit 50, for example. The “classification index” here is an index indicating a likelihood of the class to which the serial data belong. A specific example and a specific calculation method of the classification index will be described in detail in another example embodiment described later.

The class selection unit 200 is configured to select and output, from N classes that are classification candidates of the series data (where N is a natural number), K classes to which the series data are likely to belong (where K is a natural number that is less than or equal to N and that is greater than or equal to 1), on the basis of the classification index calculated by the index calculation unit 100. The N classes that are the classification candidates may be set in advance. Alternatively, the N classes that are the classification candidates may be set by the user as appropriate, or may be set on the basis of the type of the series data to be handled, as appropriate. On the other hand, the K classes are a plurality of classes selected by the class selection unit 200 from the N classes that are the classification candidates. The class selection unit 200, however, may exceptionally select only one class when it cannot select a plurality of classes (i.e., in principle, K≥2, but exceptionally K=1). More specific processing content of the class selection unit 200 (i.e., a method of selecting the K classes) will be described in detail in another example embodiment described later.

### (Flow of Operation)

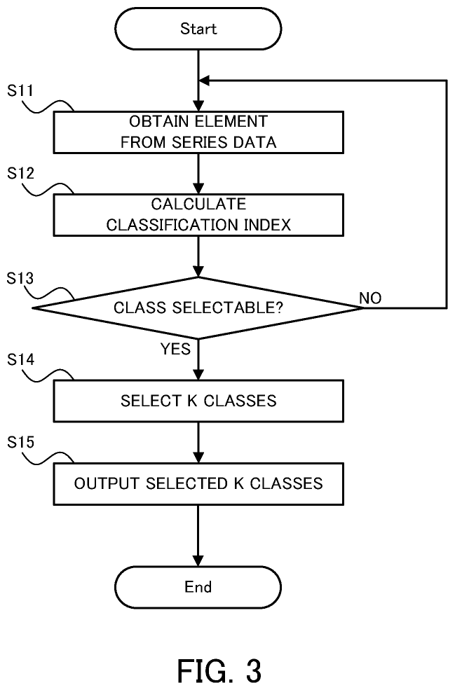

Next, a flow of operation of the information processing apparatus 10 according to the first example embodiment will be described with reference to FIG. 3. FIG. 3 is a flowchart illustrating the flow of the operation of the information processing apparatus according to the first example embodiment.

As illustrated in FIG. 3, when the operation of the information processing apparatus 10 according to the first example embodiment is started, first, the acquisition unit 50 obtains one element from the series data (step S11). The acquisition unit 50 outputs the obtained element of the series data to the index calculation unit 100. Then, the index calculation unit 100 calculates the classification index on the basis of the obtained two or more elements (step S12).

Subsequently, the class selection unit 200 determines whether or not the K classes (i.e., the classes to which the serial data are likely to belong) are selectable on the basis of the calculated classification index (step S13). A criterion here will be described in detail in another example embodiment described later. When the class selection unit 200 determines that the K classes are not selectable on the basis of the calculated classification index (the step S13: NO), the information processing apparatus 10 restarts the process from the step S11. That is, the information processing apparatus 10 obtains a next element of the series data and newly calculates the classification index.

On the other hand, when determining that the K classes are selectable on the basis of the calculated classification index (the step S13: YES), the class selection unit 200 selects the K classes on the basis of the calculated classification index (step S14). That is, the class selection unit 200 selects the K classes from the N classes that are the classification candidates. Then, the class selection unit 200 outputs information about the selected K classes (step S15). The class selection unit 200 may provide the series data with a label corresponding to the selected K classes.

### (Technical Effect)

Next, a technical effect obtained by the information processing apparatus 10 according to the first example embodiment will be described.

As described in FIG. 1 to FIG. 3, in the information processing apparatus 10 according to the first example embodiment, the classification index is calculated on the basis of at least two elements of the series data. Then, the K classes are selected from the N classes that are the classification candidates of the serial data, on the basis of the classification index. In this way, it is possible to properly determine to which class the series data may belong, in view of at least two elements included in the series data. In addition, since the selected K classes are a plurality of classes, it is possible to determine the class more flexibly than when only one class is selected. For example, a useful effect is achieved when a correct answer is a plurality of classes, or when the user wants to determine one correct answer from a plurality of classes selected as the candidates. A specific application example of the information processing apparatus 10 according to the example embodiment will be described in detail in another example embodiment described later.

### Second Example Embodiment

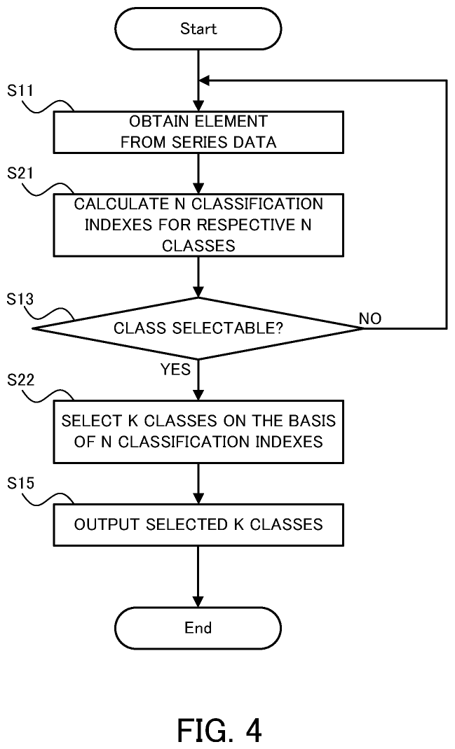

The information processing apparatus 10 according to a second example embodiment will be described with reference to FIG. 4. The second example embodiment is partially different from the first example embodiment only in the operation, and may be the same as the first example embodiment in the apparatus configuration (see FIG. 1 and FIG. 2) or the like, for example. For this reason, a part that is different from the first example embodiment will be described in detail below, and a description of other overlapping parts will be omitted as appropriate.

### (Flow of Operation)

First, with reference to FIG. 4, a flow of operation of the information processing apparatus 10 according to the second example embodiment will be described. FIG. 4 is a flowchart illustrating the flow of the operations of the information processing apparatus according to the second example embodiment. In FIG. 4, the same steps as those illustrated in FIG. 3 carry the same reference numerals.

As illustrated in FIG. 4, when the operation of the information processing apparatus 10 according to the first example embodiment is started, first, the acquisition unit 50 obtains one element from the series data (step S11). The acquisition unit 50 outputs the obtained element of the series data to the index calculation unit 100.

Especially in the second example embodiment, the index calculation unit 100 calculates the classification index for each of the N classes that are the classification candidates (step S21). For example, when the N classes that are the classification candidates include a class A, a class B, class C, class D, and so on, the index calculation unit 100 calculates N classification indexes corresponding to respective classes, such as a classification index of the class A, a classification index of the class B, a classification index of the class C, a classification index of the class D, and so on.

Subsequently, the class selection unit 200 determines whether or not the K classes (i.e., the classes to which the serial data are likely to belong) are selectable on the basis of the calculated N classification indexes (step S13). When the class selection unit 200 determines that the K classes are not selectable on the basis of the calculated N classification indexes (the step S13: NO), the information processing apparatus 10 restarts the process from the step S11. That is, the information processing apparatus 10 obtains a next element of the series data and newly calculates the classification index.

On the other hand, when determining that the K classes are selectable on the basis of the calculated N classification indexes (the step S13: YES), the class selection unit 200 selects the K classes on the basis of the calculated N classification indexes (step S22). Then, the class selection unit 200 outputs information about the selected K classes (step S15).

### (Technical Effect)

Next, a technical effect obtained by the information processing apparatus 10 according to the second example embodiment will be described.

As described in FIG. 4, in the information processing apparatus 10 according to the second example embodiment, the classification index is calculated for each of the N classes (i.e., the N classification indexes are calculated). Thus, if the N classification indexes are calculated, it is possible to properly select the K classes to which the serial data are likely to belong, from the N classes that are the classification candidates. For example, whether or not the series data are likely to belongs to the class A included in the N classes (in other words, whether or not to select the class A as the K classes) may be determined on the basis of the classification index calculated corresponding to the class A. Similarly, whether or not the series data are likely to belongs to the class B included in the N classes (in other words, whether or not to select the class B as the K classes) may be determined on the basis of the classification index calculated correspondingly to the class B.

### Third Example Embodiment

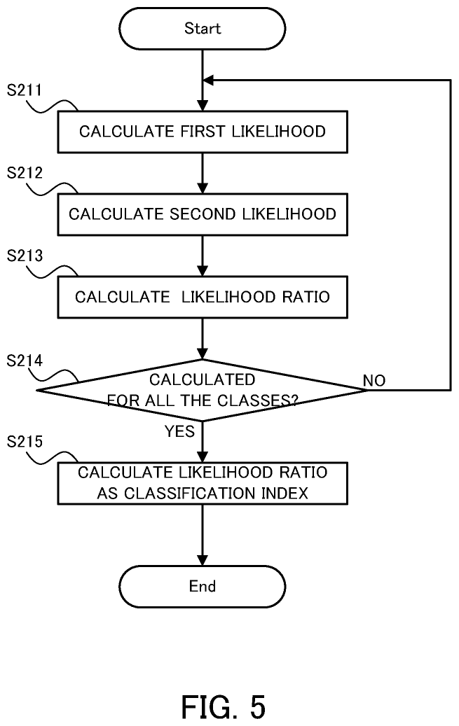

The information processing apparatus 10 according to a third example embodiment will be described with reference to FIG. 5. The third example embodiment shows a specific method of calculating the N classification indexes in the second example embodiment, and may be the same as the second example embodiment in the apparatus configuration and the overall flow of the overall. For this reason, a part that is different from the second example embodiment will be described in detail below, and a description of other overlapping parts will be omitted as appropriate.

### (Flow of Operation)

First, a flow of a classification index calculation process (i.e., the step S21 in FIG. 4) in the information processing apparatus 10 according to the third example embodiment will be described with reference to FIG. 5. FIG. 5 is a flowchart illustrating the flow of the classification index calculation processing in the information processing apparatus according to the third example embodiment.

As illustrated in FIG. 5, when the classification index calculation process is started in the information processing apparatus 10 according to the third example embodiment, the index calculation unit 100 firstly calculates a first likelihood for one class included in the N classes that are the classification candidates (step S211). The first likelihood here is a value indicating a likelihood that the serial data belong to a certain class, and can be expressed as p(X|y=1) (y=1 means a state in which the serial data belong to a certain class), for example.

Subsequently, the index calculation unit 100 calculates a second likelihood for the one class for which the first likelihood is calculated (step S212). The second likelihood here is a value indicating a likelihood that the serial data do not belong to a certain class, and can be expressed as p(X|y=0) (y=0 means a state in which the serial data do not belong to a certain class), for example.

Subsequently, the index calculation unit 100 calculates a likelihood ratio that is a ratio between the first likelihood and the second likelihood that are already calculated (step S213). This likelihood ratio can be expressed as p (X|y=1)/p (X|y=0), for example. The above method of calculating the likelihood ratio is merely an example, and the likelihood ratio may be calculated by using another technique. The likelihood ratio will be described in detail again in another example embodiment described later.

Subsequently, the index calculation unit 100 determines whether or not the likelihood ratio is calculated for all of the N classes that are the classification candidates (step S214). When the likelihood ratio is not calculated for all the N classes that are the classification candidates (the step S214: NO), the index calculation unit 100 repeats the same process (i.e., the step S211 to the step S213) for the other classes for which the likelihood ratio is not calculated. On the other hand, when the likelihood ratio is calculated for all the N classes that are the classification candidates (the step S214: YES), the index calculation unit 100 outputs the calculated likelihood ratio (specifically, N likelihood ratios calculated for the respective N classes) as the classification index (step S215).

### (Technical Effect)

Next, a technical effect obtained by the information processing apparatus 10 according to the third example embodiment will be described.

As described in FIG. 5, in the information processing apparatus 10 according to the third example embodiment, the likelihood ratio is calculated as the classification index, wherein the likelihood ratio is a ratio between the first likelihood indicating a likelihood that the series data belong to a certain class and the second likelihood indicating a likelihood that the series data do not belong to a certain class. If such a likelihood ratio is used for the classification index, it is possible to properly select the K classes to which the serial data are likely to belong, from the N classes that are the classification candidates.

### Fourth Example Embodiment

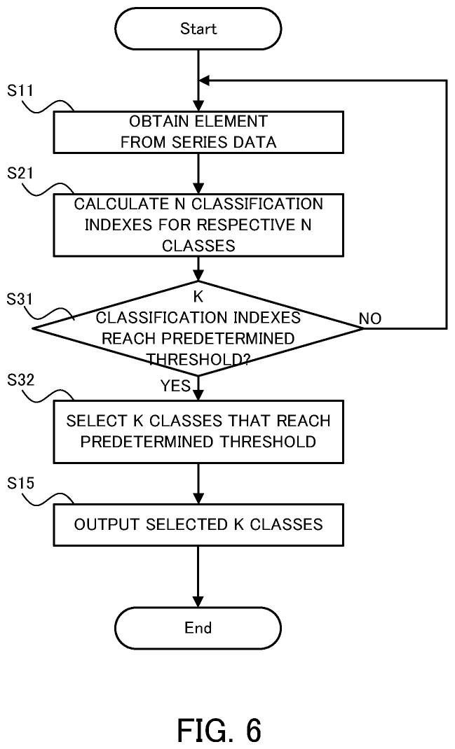

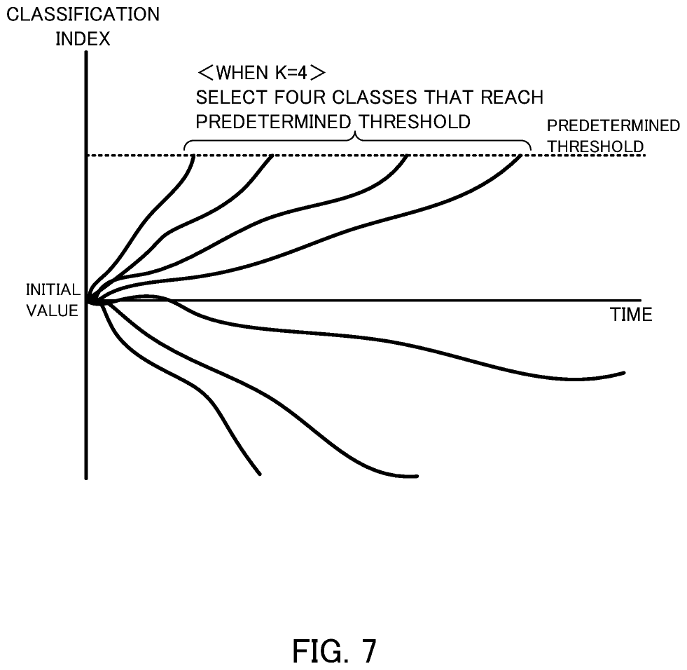

The information processing apparatus 10 according to a fourth example embodiment will be described with reference to FIG. 6 and FIG. 7. The fourth example embodiment is partially different from the first to third example embodiments only in the operation, and may be the same as the first to third example embodiments in the other operation and apparatus configuration. For this reason, a part that is different from the first to third example embodiments will be described in detail below, and a description of other overlapping parts will be omitted as appropriate.

### (Flow of Operation)

First, a flow of operation of the information processing apparatus 10 according to the fourth example embodiment will be described with reference to FIG. 6. FIG. 6 is a flowchart illustrating the flow of the operations of the information processing apparatus according to the fourth example embodiment. In FIG. 6, the same steps as those illustrated in FIG. 3 and FIG. 4 carry the same reference numerals.

As illustrated in FIG. 6, when the operation of the information processing apparatus 10 according to the fourth example embodiment is started, first, the acquisition unit 50 obtains one element from the series data (step S11). The acquisition unit 50 outputs the obtained element of the series data to the index calculation unit 100. Then, the index calculation unit 100 calculates the classification index for each of the N classes that are the classification candidates (step S21).

Subsequently, the class selection unit 200 determines whether or not K classification indexes of the calculated N classification indexes reach a predetermined threshold (step S31). Here, the “predetermined threshold” is a threshold for determining that the serial data are likely to belong to the corresponding class on the basis of the classification index, and may be set in advance by prior simulation or the like, for example. Alternatively, the predetermined threshold may be set by the user as appropriate. The predetermined threshold may be set as a threshold that is common to all of the N classification indexes, or may be set as N thresholds corresponding to the respective N classification indexes.

When the K classification indexes of the calculated N classification indexes do not reach the predetermined threshold (the step S31: NO), the information processing apparatus 10 restarts the process from the step S11. That is, the information processing apparatus 10 obtains a next element of the series data and newly calculates the classification index. On the other hand, when the K classification indexes of the calculated N classification indexes reach the predetermined threshold (the step S31: YES), the class selection unit 200 selects classes (i.e., K classes) corresponding to the K classification indexes that reach the predetermined threshold (step S32). Then, the class selection unit 200 outputs information about the selected K classes (step S15).

### (Specific Operation Example)

Next, with reference to FIG. 7, a specific operation example (a specific example of selecting the K classes) of the information processing apparatus 10 according to the fourth example embodiment will be described. FIG. 7 is a graph illustrating a class selection example in the information processing apparatus according to the fourth example embodiment. The following exemplifies that the classification indexes are calculated as the likelihood ratio described in the third example embodiment.

As illustrated in FIG. 7, the N (seven in the figure) classification indexes corresponding to the N classes that are the classification candidates vary over time from an initial value. Specifically, the N classification indexes gradually vary at each time that a next element of the series data is obtained and the classification index is calculated. Here, when it can be determined that the serial data are likely to belong to the classification index, the classification index gradually increases (i.e., it varies upward in the figure). On the other hand, when it can be determined that the serial data are unlikely to belong to the classification index, the classification index gradually decreases (i.e., it varies downward in the figure).

As the classification index continues to increase, it eventually reaches the predetermined threshold. The information processing apparatus 10 according to the fourth example embodiment selects the K classes in order from the earliest arrival time when the classification index reaches the predetermined threshold. For example, in the example illustrated in FIG. 7, K=4 is set. Therefore, when four of the seven classification indexes reach the predetermined threshold, classes corresponding to the four classification indexes are selected as the K classes to which the serial data are likely to belong. On the other hand, three classes corresponding to the other three classification indexes that do not reach the predetermined threshold, are not selected as the K classes to which the serial data are likely to belong. The classes that are not selected as the K classes are not normally outputted, but it is also possible to utilize information about the classes that are not selected as the K classes. For example, out of the classes that are not selected as the K classes, a class with the classification index that is the farthest from the predetermined threshold may be outputted as a reference information (i.e., presented to the user), or may be excluded when the process is performed on similar series data. Alternatively, out of the classes that are not selected as the K classes, a class with the classification index that reaches a second threshold set on a negative side (e.g., see a rejection threshold described later) at the earliest may be outputted as the reference information, or may be excluded when the process is performed on similar series data.

When the K classes are selected as described above, the classification index calculation process may be performed until the K classification indexes reach the predetermined threshold. In other words, the classification index calculation process may be stopped when the K classification indexes reach the predetermined threshold. In addition, for the classified index that reach the predetermined threshold, the calculation process may be stopped at that time point.

A rejection threshold may be set separately from the predetermined threshold described above. The rejection threshold is a threshold for determining that the serial data are unlikely to belong to the corresponding class on the basis of the classification index, and may be set in advance by prior simulation or the like, for example. Alternatively, the rejection threshold may be set by the user as appropriate. The rejection threshold may be set as a threshold that is common to all of the N classification indexes, or may be set as N thresholds corresponding to the respective N classification indexes. The rejection threshold is typically set to be sufficiently lower than the initial value.

As the classification index continues to decrease, it eventually reaches the rejection threshold. For the classification index that reaches the rejection threshold, the calculation process may be stopped at that time point. In other words, it may be determined that the classification index is unlikely to increase to reach the predetermined threshold, and the subsequent calculation process may be stopped.

### (Technical Effect)

Next, a technical effect obtained by the information processing apparatus 10 according to the fourth example embodiment will be described.

As described in FIG. 6 and FIG. 7, in the information processing apparatus 10 according to the fourth example embodiment, the K classes to which the serial data are likely to belong are selected in order from the earliest arrival time when the classification index reaches the predetermined threshold. In this way, it is possible to easily and accurately select the K classes. Furthermore, it is possible to properly reduce a processing load by stopping the classification index calculation process when the K classification indexes reach the predetermined threshold. In addition, even for the classification index that reaches the predetermined threshold or the rejection threshold, it is possible to properly reduce a subsequent processing load by stopping the classification index calculation process when the classification index reaches each of the thresholds.

### Modified Example of Fourth Example Embodiment

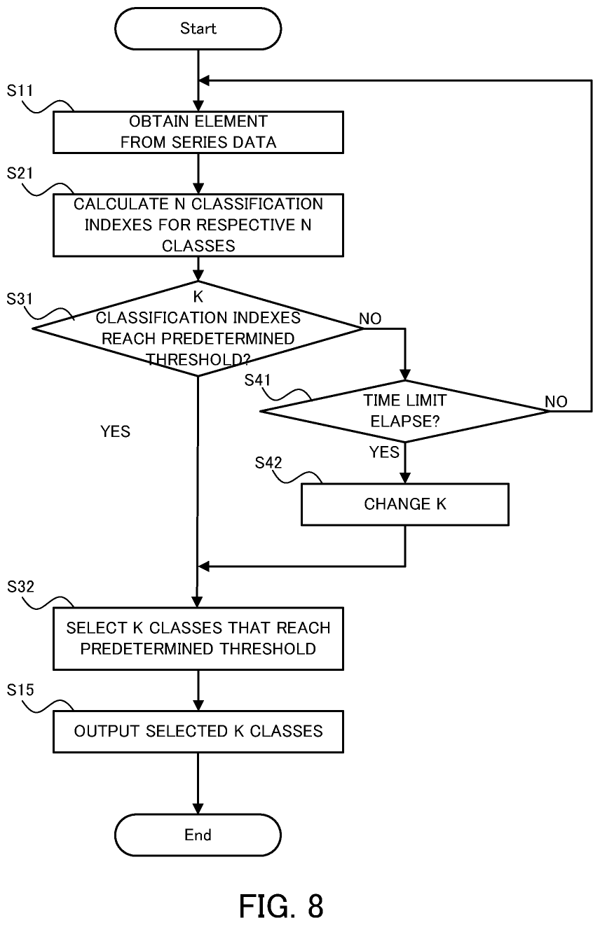

Next, the information processing apparatus 10 according to a modified example of the fourth example embodiment will be described with reference to FIG. 8. The modified example of the fourth example embodiment of the information processing apparatus 10 is partially different from the fourth example embodiment only in the operation, and may be the same as those of the fourth example embodiment in the other operation and apparatus configuration. For this reason, a part that is different from the fourth example embodiment will be described in detail below, and a description of other overlapping parts will be omitted as appropriate.

### (Flow of Operation)

First, a flow of operation of the information processing apparatus 10 according to the modified example of the fourth example embodiment will be described with reference to FIG. 8. FIG. 8 is a flowchart illustrating the flow of the operations of the information processing apparatus according to the modified example of the fourth example embodiment. In FIG. 8, the same steps as those illustrated in FIG. 6 carry the same reference numerals.

As illustrated in FIG. 8, when the operation of the information processing apparatus 10 according to the modified example of the fourth example embodiment is started, first, the acquisition unit 50 obtains one element from the series data (step S11). The acquisition unit 50 outputs the obtained element of the series data to the index calculation unit 100. Then, the index calculation unit 100 calculates the classification index for each of the N classes that are the classification candidates (step S21).

Subsequently, the class selection unit 200 determines whether or not K classification indexes of the calculated N classification indexes reach a predetermined threshold (step S31). When the K classification indexes of the calculated N classification indexes reach the predetermined threshold (the step S31: YES), the class selection unit 200 selects classes (i.e., K classes) corresponding to the K classification indexes that reach the predetermined threshold (step S32). Then, the class selection unit 200 outputs information about the selected K classes (step S15).

On the other hand, when the K classification indexes of the calculated N classification indexes do not reach the predetermined threshold (the step S31: NO), the class selection unit 200 determines whether or not a time limit elapses after a series of processing steps as illustrated in the flowchart is started (step S41). The “time limit” here is a value that is set as the longest time for performing a series of processing steps, and an optimum value is determined by prior simulation or the like, for example. The time limit may be changeable, as appropriate, by the operation of the user or the like.

When it is determined that the time limit does not elapse (the step S41: NO), the information processing apparatus 10 determines that a series of processing steps may be continued, and restarts the process from the step S11. That is, the information processing apparatus 10 obtains a next element of the series data and newly calculates the classification index. On the other hand, when it is determined that the limit time elapses (the step S41: YES), the information processing apparatus 10 determines that a series of processing steps should not be continued, stops the classification index calculation process, and shifts to a process of outputting the K classes.

Specifically, the class selection unit 200 sets K for the number of the classification indexes that reach the predetermined threshold when the time limit elapses (step S42). For example, when an original value of K is 4 and when there are only two classified indexes that reach the predetermined threshold when the time limit elapses, the class selection unit 200 changes the value of K from 4 to 2. Similarly, when there is only one classification index that reaches the predetermined threshold when the time limit elapses, the class selection unit 200 changes the value of K from 4 to 1. That is, the class selection unit 200 here performs a process of forcibly reducing the value of K to a currently selectable value.

Then, the class selection unit 200 selects classes corresponding to the K (the value after change) classification indexes that reach the predetermined threshold (step S32). Then, the class selection unit 200 outputs information about the selected K classes (step S15).

### (Technical Effect)

Next, a technical effect obtained by the information processing apparatus 10 according to a modified example of the fourth example embodiment will be described.

As described in FIG. 8, in the information processing apparatus 10 according to the modified example of the fourth example embodiment, when the limit time elapses, even if the number of the classification indexes that reach the predetermined threshold at that time point is less than the original value of K, K is forcibly reduced, and classes corresponding to the classification indexes that already reach the predetermined threshold are selected as the K classes. In this way, it is possible to avoid such an inconvenience that the K classes are not outputted even when a long time elapses (i.e., such an inconvenience that the classes cannot be selected because the number of the classification indexes that reach the predetermined threshold is less than K). The fourth example embodiment is an example of a configuration for variably setting the value of K. If the value of K is set variable in this way, it is possible to select the classes more flexibly, compared with when the value of K is fixed.

### Fifth Example Embodiment

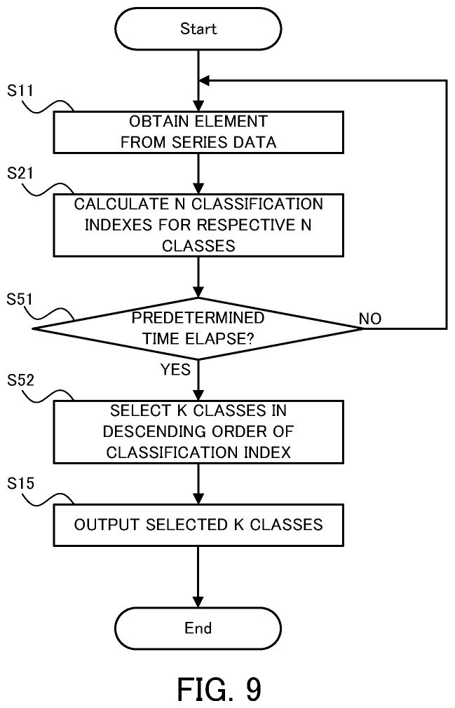

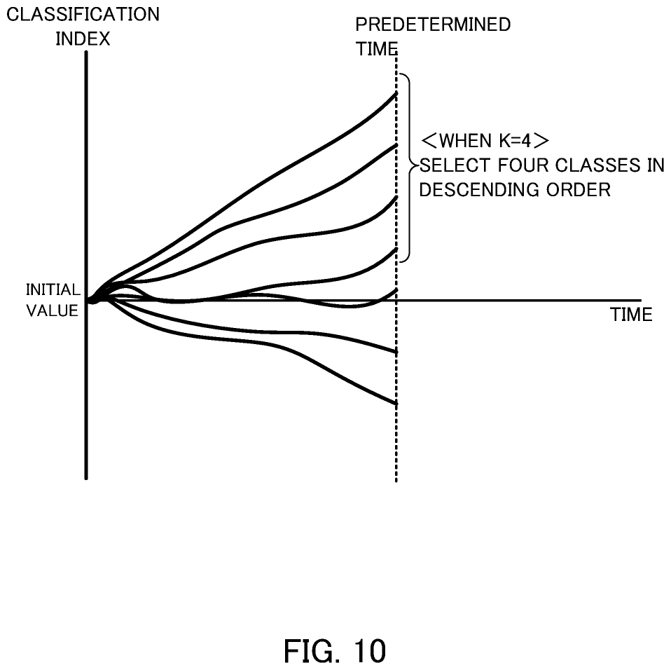

The information processing apparatus 10 according to a fifth example embodiment will be described with reference to FIG. 9 and FIG. 10. The fifth example embodiment is partially different from the first to fourth example embodiments only in the operation, and may be the same as the first to fourth example embodiments in the other operation and apparatus configuration. For this reason, a part that is different from the first to fourth example embodiments will be described in detail below, and a description of other overlapping parts will be omitted as appropriate.

### (Flow of Operation)

First, a flow of operation of the information processing apparatus 10 according to the fifth example embodiment will be described with reference to FIG. 9. FIG. 9 is a flowchart illustrating the flow of the operation of the information processing apparatus according to the fifth example embodiment. In FIG. 9, the same steps as those illustrated in FIG. 4 carry the same reference numerals.

As illustrated in FIG. 9, when the operation of the information processing apparatus 10 according to the fifth example embodiment is started, first, the acquisition unit 50 obtains one element from the series data (step S11). The acquisition unit 50 outputs the obtained element of the series data to the index calculation unit 100. Then, the index calculation unit 100 calculates the classification index for each of the N classes that are the classification candidates (step S21).

Subsequently, the class selection unit 200 determines whether or not a predetermined time elapses after a series of processing steps illustrated in the flowchart is started (step S51). Here, the “predetermined time” is a value that is set as the longest time for performing a series of processing steps, and an optimum value is determined by prior simulation or the like, for example. The predetermined time may be changeable, as appropriate, by the operation of the user or the like.

When it is determined that the predetermined period does not elapse (the step S51: NO), the information processing apparatus 10 restarts the process from the step S11. That is, the information processing apparatus 10 obtains a next element of the series data and newly calculates the classification index. On the other hand, when it is determined that the predetermined time elapses (the step S51: YES), the class selection unit 200 selects the K classes in descending order of the classification index when the predetermined time elapses (step S52). Then, the class selection unit 200 outputs information about the selected K classes (step S15).

### (Specific Operation Example)

Next, with reference to FIG. 10, a specific operation example (a specific example of selecting the K classes) of the information processing apparatus 10 according to the fifth example embodiment will be described. FIG. 10 is a graph illustrating a class selection example in the information processing apparatus according to the fifth example embodiment. The following exemplifies that the classification indexes are calculated as the likelihood ratio described in the third example embodiment.

As illustrated in FIG. 10, the N (seven in the figure) classification indexes corresponding to the N classes that are the classification candidates vary over time from an initial value. Specifically, the N classification indexes gradually vary at each time that a next element of the series data is obtained and the classification index is calculated. Here, when it can be determined that the serial data are likely to belong to the classification index, the classification index gradually increases (i.e., it varies upward in the figure). On the other hand, when it can be determined that the serial data are unlikely to belong to the classification index, the classification index gradually decreases (i.e., it varies downward in the figure).

In the information processing apparatus 10 according to the fifth example embodiment, when the predetermined time elapses after the process is started, the classification index calculation process is stopped at that time point, and the K classes are selected in descending order of the classification index. That is, classes corresponding to the classification indexes up to the K-th classification index in descending order of the classification index are selected as the K classes to which the serial data are likely to belong. In the example illustrated in FIG. 10, K=4 is set. Therefore, classes corresponding to the classification indexes up to the fourth classification index in descending order out of the seven classification indexes, are selected as the K classes to which the serial data are likely to belong. On the other hand, three classes corresponding to the other three classification indexes that do not reach the predetermined threshold, are not selected as the K classes to which the serial data are likely to belong. As in the fourth example embodiment (e.g., see FIG. 7) described above, a predetermined threshold may be set, and the K classes may be selected when the classification index reaches the predetermined threshold. Specifically, the classification index calculation process may be stopped when one of the classification indexes reaches the predetermined threshold, and the K classes may be selected in descending order of the classification index at that time point.

When a classification index that preferably should not be selected (e.g., a classification index that is smaller than the initial value) is included in the classification indexes up to the K-th classification index in descending order, a class corresponding to the classification index may not be selected. In this case, the number of the K classes to be outputted is smaller than the value of K that is originally set. Such a configuration is an example of a configuration for variably setting the value of K.

Furthermore, in order to avoid the reduced K described above, a plurality of predetermined times may be set in stages. For example, when the classification index that should not be selected is included in the classification indexes up to the K-th classification index in descending order at a time point at which a first predetermined time elapses, the K classes may not be selected and the process may be continued until a second predetermined time elapses, wherein the second predetermined time is longer than the first predetermined time. Then, when the second predetermined time elapses after the process is continued, the classification indexes up to the K-th classification index in descending order may be selected.

For example, it is assumed that K=4 is set. At this time, when the classification index that should not be selected is not included at the time point at which the first predetermined time elapses, the class selection unit 200 selects and outputs the four classification indexes as it is. On the other hand, when the classification index that should not be selected is included at the time point at which the first predetermined time elapses, the class selection unit 200 does not output the classification index at that time point, and continues the process. Then, when the second predetermined time elapses, the classification indexes up to the K-th classification index in descending order may be selected.

When a plurality of predetermined times are set, the user may be asked whether or not to further continue the process when the first predetermined time elapses. In this case, if the user answers that process may be continued, the process is continued until the next predetermined time elapses depending on the situation, even after a lapse of the first predetermined time. On the other hand, if the user answers that the process is not continued, the K classes may be selected and outputted at that time point.

### (Technical Effect)

Next, a technical effect obtained by the information processing apparatus 10 according to the fifth example embodiment will be described.

As described in FIG. 9 and FIG. 10, in the information processing apparatus 10 according to the fifth example embodiment, the K classes are selected in descending order of the classification index when the predetermined time elapses. In this way, it is possible to reliably output the K classes within a time set in advance. As a result, it is possible to avoid such an inconvenience that the K classes are not outputted even when a long time elapses.

### Sixth Example Embodiment

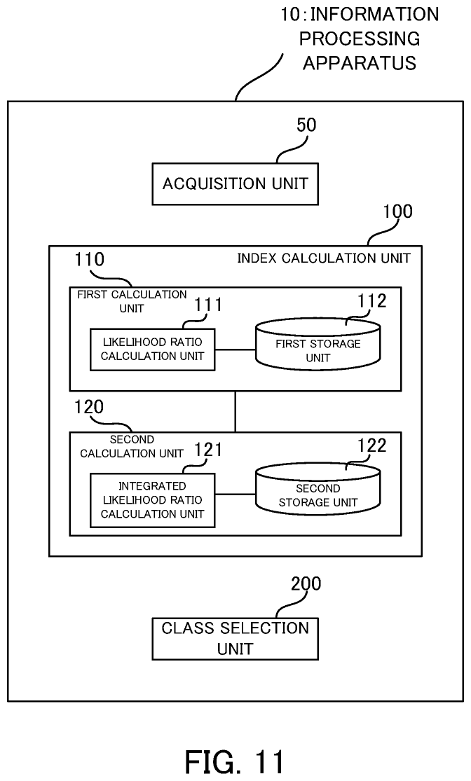

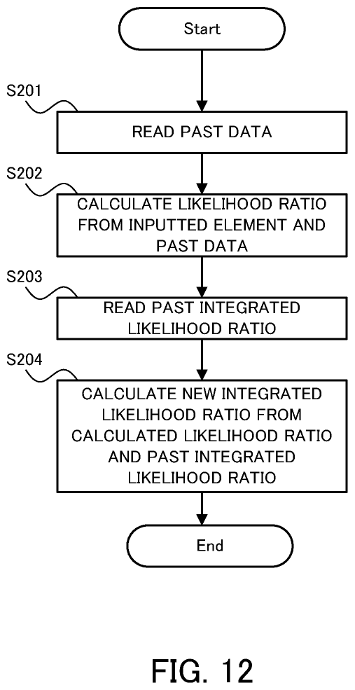

The information processing apparatus 10 according to a sixth example embodiment will be described with reference to FIG. 11 and FIG. 12. The sixth example embodiment is partially different from the first to fifth example embodiments in the configuration and operation, and may be the same as the first to fifth example embodiments in the hardware configuration and the flow of the overall operation, for example. For this reason, a part that is different from the first to fifth example embodiments will be described in detail below, and a description of other overlapping parts will be omitted as appropriate.

### (Functional Configuration)

First, with reference to FIG. 11, a functional configuration of the information processing apparatus 10 according to the sixth example embodiment will be described. FIG. 11 is a block diagram illustrating the functional configuration of the information processing apparatus according to the sixth example embodiment. In FIG. 11, the same components as those illustrated in FIG. 2 carry the same reference numerals.

As illustrated in FIG. 11, the information processing apparatus 10 according to the sixth example embodiment includes, as processing blocks for realizing its functions, the acquisition unit 50, the index calculation unit 100, and the class selection unit 200. Especially in the sixth example embodiment, the acquisition unit 50 is configured to sequentially obtain the elements included in the series data. The index calculation unit 100 includes a first calculation unit 110 and a second calculation unit 120. The first calculation unit 110 includes a likelihood ratio calculation unit 111 and a first storage unit 112. The second calculation unit 120 includes an integrated likelihood ratio calculation unit 121 and a second storage unit 122. Each of the likelihood ratio calculation unit 111 and the integrated likelihood ratio calculation unit 121 may be realized or implemented by the processor 11 (see FIG. 1). Furthermore, each of the first storage unit 112 and the second storage unit 122 may be realized or implemented by the storage apparatus 14 (see FIG. 1).

The likelihood ratio calculation unit 111 is configured to calculate the likelihood ratio for each of the elements obtained by the acquisition unit 50. The likelihood ratio is a value indicating a likelihood that each element belongs to a certain class of a plurality of classes. The likelihood ratio calculation unit 111 calculates the likelihood ratio on the basis of the obtained element and past data stored in the first storage unit 112. The information stored in the first storage unit 112 is configured to be read by the likelihood ratio calculation unit 111. When the first storage unit 112 stores a past likelihood ratio, the likelihood ratio calculation unit 111 may read the stored past likelihood ratio and may calculate the likelihood ratio for the obtained element. On the other hand, when the first storage unit 112 stores the element obtained in the past, the likelihood ratio calculation unit 111 may calculate a past likelihood ratio from the stored past element and may calculate the likelihood ratio for the obtained element. The following describes a specific example of the likelihood ratio.

It is assumed that N elements that constitute the series data are x₁, . . . , and x_{N} and a plurality of classes are R and F. Given that one of the two classes is in a state of being a certain class and the other is in a state of not being a certain class, it can be considered as in the case described in the third example embodiment. For convenience of explanation, the two classes will be referred to as a class R and a class F.

Here, for a probability that an element xᵢ belongs to the class R, a result calculated without considering the past data is expressed as p(R|xᵢ). Furthermore, for a probability that the element xᵢ belongs to the class F, a result calculated without considering the past data is expressed as p(F|xᵢ). At this time, the likelihood ratio between these is expressed by the following equation (1).

$$\begin{matrix}[ Equation 1 ] & \\ \frac{p ( R \vert {x}_{i} )}{p ( F \vert {x}_{i} )} & ( 1 )\end{matrix}$$

The likelihood ratio in the equation (1) indicates a ratio of a likelihood between the probability that the element xᵢ belongs to the class R and the probability that the element xᵢ belongs to the class F. For example, when the likelihood ratio is greater than 1, p(R|xᵢ)>p(F|xᵢ). Thus, the element x, maybe classified into the class R rather than the class F. In this way, the likelihood ratio in the equation (1) functions as an index indicating to which of the class R and the class F the inputted element belongs.

Furthermore, the likelihood ratio calculation unit 111 is also configured to perform the calculation in view of a plurality of elements (i.e., continuity of the past data and the inputted element) as described above. In this case, for example, the likelihood ratio calculated in view of two elements xᵢ and xᵢ₋₁ is expressed by the following equation (2).

$$\begin{matrix}[ Equation 2 ] & \\ \frac{p ( R \vert {x}_{i} , {x}_{i - 1} )}{p ( F \vert {x}_{i} , {x}_{i - 1} )} & ( 2 )\end{matrix}$$

The integrated likelihood ratio calculation unit 121 is configured to calculate an integrated likelihood ratio that is a classification index. The integrated likelihood ratio is a value indicating a likelihood that serial data belong to a certain class of a plurality of classes. The integrated likelihood ratio calculation unit 121 calculates the integrated likelihood ratio by using the likelihood ratio calculated by the likelihood ratio calculation unit 111 and a past integrated likelihood ratio stored in the second storage unit 122. Information stored in the second storage unit 122 (i.e., the past integrated likelihood ratio) is configured to be read by the integrated likelihood ratio calculation unit 121. Hereinafter, a specific example of the integrated likelihood ratio will be described. As in the description of the likelihood ratio described above, a description will be given to a two-class classification in which the number of the classes is two.

When the N elements are inputted at a time point of calculating the integrated likelihood ratio, these N elements are expressed as x₁, . . . , and x_{N}. Here, a probability that the entire series data belong to the class R is expressed as p(x₁, . . . , and x_{N}|R). In addition, a probability that the entire series data belong to the class F is expressed as p(x₁, . . . , and x_{N}|F). In this case, the likelihood ratio between these is expressed by the following equation (3). The equation (3) is referred to as the integrated likelihood ratio.

$$\begin{matrix}[ Equation 3 ] & \\ \frac{p ( {x}_{1} , … , {x}_{N} \vert R )}{p ( {x}_{1} , … , {x}_{N} \vert F )} & ( 3 )\end{matrix}$$

When it is assumed that each element of the serial data is independent, the integrated likelihood ratio can be calculated by decomposition into element-by-element terms, as illustrated in the following equation (4).

$$\begin{matrix}[ Equation 4 ] & \\ log [ \frac{p ( {x}_{1} , … , {x}_{N} \vert R )}{p ( {x}_{1} , … , {x}_{N} \vert F )} ] = {\sum }_{i = 1}^{N} log [ \frac{p ( R \vert {x}_{i} )}{p ( F \vert {x}_{i} )} ] & ( 4 )\end{matrix}$$

In the above equation (4), a logarithm of the likelihood ratio is used for simplification of calculation, thereby to decompose each element into a sum; however, this is not essential. In the following, a term of the likelihood ratio or the integrated likelihood ratio may be used for such a logarithm likelihood ratio. Although the notation of a base of the logarithm is omitted, the base has an arbitrary value.

In the example embodiment, however, as described above, since the likelihood ratio and the integrated likelihood ratio are calculated in view of two or more elements, the assumption that each element is independent is not satisfied in many cases. Therefore, it is hardly possible to perform the decomposition into the element-by-element terms as in the equation (4), and the integrated likelihood ratio is calculated by a different calculation equation in accordance with the number of the elements for which a relation is considered.

For example, when two elements that are a certain element and a previous element that is one before the certain element, are considered, the integrated likelihood ratio can be calculated by using the following equation (5).

$$\begin{matrix}[ Equation 5 ] & \\ log [ \frac{p ( {x}_{1} , … , {x}_{N} \vert R )}{p ( {x}_{1} , … , {x}_{N} \vert F )} ] = {\sum }_{i = 2}^{N} log [ \frac{p ( R \vert {x}_{i} , {x}_{i - 1} )}{p ( F \vert {x}_{i} , {x}_{i - 1} )} ] - {\sum }_{i = 2}^{N} log [ \frac{p ( R \vert {x}_{i} )}{p ( F \vert {x}_{i} )} ] & ( 5 )\end{matrix}$$

### (Flow of Index Calculation Process)

Next, with reference to FIG. 12, a flow of an index calculation process (i.e., a process of calculating the likelihood ratio and the integrated likelihood ratio) by the information processing apparatus 10 according to the sixth example embodiment will be described. FIG. 12 is a flowchart illustrating a flow of the classification index calculation process in the information processing apparatus according to the sixth example embodiment.

As illustrated in FIG. 12, in the index calculation processing according to the sixth example embodiment, first, the likelihood ratio calculation unit 111 of the first calculation unit 110 reads the past data from the first storage unit 112 (step S201). The past data maybe, for example, a processing result (in other words, a likelihood ratio calculated for the previous element) in the likelihood ratio calculation unit 111, for the previous element that is obtained one before the element that is obtained this time by the acquisition unit 50. Alternatively, the past data may be the previous element itself that is obtained one before the element that is obtained this time by the acquisition unit 50.

Subsequently, the likelihood ratio calculation unit 111 calculates a new likelihood ratio (i.e., a likelihood ratio with respect to the element obtained this time by the acquisition unit 50), on the basis of the element obtained by the acquisition unit 50 and the past data read from the first storage unit 112 (step S202). The likelihood ratio calculation unit 111 outputs the calculated likelihood ratio to the second calculation unit 120. The likelihood ratio calculation unit 111 may store the calculated likelihood ratio in the first storage unit 112.

Subsequently, the integrated likelihood ratio calculation unit 121 of the second calculation unit 120 reads the past integrated likelihood ratio from the second storage unit 122 (step S203). The past integrated likelihood ratio may be, for example, a processing result (in other words, an integrated likelihood ratio calculated for the previous element) in the integrated likelihood ratio calculation unit 121, for the previous element that is obtained one before the element that is obtained this time by the acquisition unit 50.

Subsequently, the integrated likelihood ratio calculation unit 121 calculates a new integrated likelihood ratio (i.e., an integrated likelihood ratio with respect to the element obtained this time by the acquisition unit 50), on the basis of the likelihood ratio calculated by the likelihood ratio calculation unit 111 and the past integrated likelihood ratio read from the second storage unit 122 (step S204). The integrated likelihood ratio calculation unit 121 outputs the calculated integrated likelihood ratio to the class selection unit 200. The integrated likelihood ratio calculation unit 121 may store the calculated integrated likelihood ratio in the second storage unit 122.

### (Technical Effect)

Next, a technical effect obtained by the information processing apparatus 10 according to the sixth example embodiment will be described.

As described in FIG. 11 and FIG. 12, in the information processing apparatus 10 according to the sixth example embodiment, the likelihood ratio and the integrated likelihood ratio are calculated from the elements included in the series data. Then, the calculated integrated likelihood ratio is used as the classification index. The integrated likelihood ratio is, as already described, a value that takes into account the continuity of a plurality of elements included in the serial data. Therefore, by using the integrated likelihood ratio as the classification index, it is possible to properly select the K classes to which the serial data are likely to belong.

### Seventh Example Embodiment

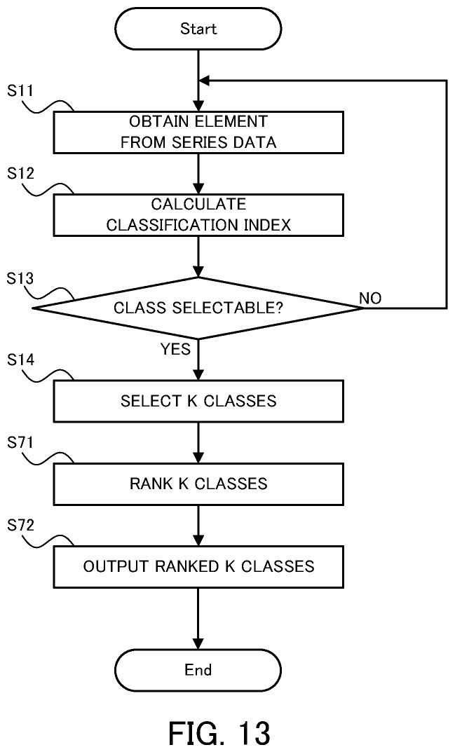

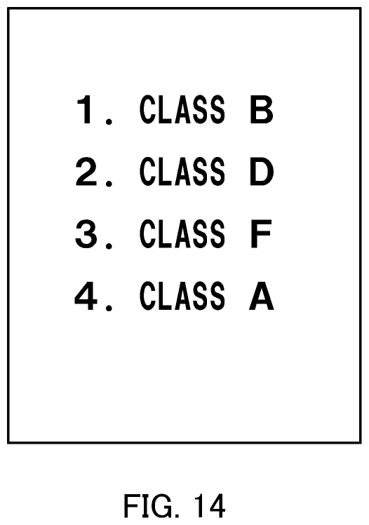

The information processing apparatus 10 according to a seventh example embodiment will be described with reference to FIG. 13 and FIG. 14. The seventh example embodiment is partially different from the first to sixth example embodiments in the operation, and may be the same as the first to sixth example embodiments in the other operation and apparatus configuration. For this reason, a part that is different from the first to sixth example embodiments will be described in detail below, and a description of other overlapping parts will be omitted as appropriate.

### (Flow of Operation)

First, with reference to FIG. 13, a flow of operation of the information processing apparatus 10 according to the seventh example embodiment will be described. FIG. 13 is a flowchart illustrating the flow of the operation of the information processing apparatus according to the seventh example embodiment. In FIG. 13, the same steps as those illustrated in FIG. 3 carry the same reference numerals.

As illustrated in FIG. 13, when the operation of the information processing apparatus 10 according to the seventh example embodiment is started, first, the acquisition unit 50 obtains one element from the series data (step S11). The acquisition unit 50 outputs the obtained element of the series data to the index calculation unit 100. Then, the index calculation unit 100 calculates the classification index on the basis of the obtained two or more elements (step S12).

Subsequently, the class selection unit 200 determines whether or not the K classes (i.e., the classes to which the serial data are likely to belong) are selectable on the basis of the calculated classification index (step S13). When the class selection unit 200 determines that the K classes are not selectable on the basis of the calculated classification index (the step S13: NO), the information processing apparatus 10 restarts the process from the step S11. That is, the information processing apparatus 10 obtains a next element of the series data and newly calculates the classification index.

On the other hand, when determining that the K classes are selectable on the basis of the calculated classification index (the step S13: YES), the class selection unit 200 selects the K classes on the basis of the calculated classification index (step S14). That is, the class selection unit 200 selects the K classes from the N classes that are the classification candidates.

Subsequently, especially in the seventh example embodiment, the class selection unit 200 ranks the selected K classes in descending order of a possibility that the serial data belong to the class (step S71). For example, as in the fourth example embodiment, when selecting the K classes on the basis of the timing when the predetermined threshold is reached, the class selection unit 200 may rank the K classes in order from the earliest arrival time when the predetermined threshold is reached. Alternatively, as in the fifth example embodiment described above, when selecting the K classes on the basis of the value of the classification index when the predetermined time elapses, the class selection unit 200 may rank the K classes in descending order of the classification index.

Then, the class selection unit 200 outputs information about the ranked K classes (step S72). That is, the class selection unit 200 outputs the information about the selected K classes together with the information about the ranks.

### (Display Example of Output Result)

Next, with reference to FIG. 14, a display example of an output result of the information processing apparatus 10 according to the seventh example embodiment will be specifically described. FIG. 14 is a diagram illustrating a display example of an outputted class by the information processing apparatus according to the seventh example embodiment

As illustrated in FIG. 14, the output result of the information processing apparatus 10 according to the seventh example embodiment may be displayed on a display apparatus, such as, for example, a display. The display apparatus in this case may be the output apparatus 16 (see FIG. 1), or may be an external display or the apparatus or the like. Furthermore, the output result of the information processing apparatus 10 may be outputted in audio via a speaker or the like, for example.

The output result of the information processing apparatus 10 according to the seventh example embodiment may be displayed in a list format such that the ranks can be understood. In the example illustrated in FIG. 14 (K=4), the rank and the name of the class are displayed in a ranking format; specifically, the first place is a class B, the second place is a class D, the third place is a class F, and the fourth place is a class A. For the ranked K classes, a numerical value indicating the value of the classification index (in other words, a quantitative value indicating how high the possibility that the serial data belong to the class is) may be displayed.

The selected K classes may be displayed in different display aspects depending on the ranks. For example, only the class in the first place may be displayed in a prominent color (e.g., red, yellow, etc.), while the unselected K classes may be displayed in a relatively non-prominent color (e.g., black, brown, etc.). Furthermore, only the class in the first place may be displayed flashing, while the classes in the other ranks may be displayed without flashing. In addition, a higher-rank class may be displayed with larger font or bold characters.

The display aspect of a screen may be configured to be changed as appropriate by the user's operation or the like. For example, by the user's operation, a state in which the ranks are displayed in descending order may be switched to a state in which the ranks are displayed in ascending order. Furthermore, by the user's operation, ON/OFF of the display aspect corresponding to the rank may be switched. By the user's operation, any of the selected K classes may not be displayed (i.e., may be deleted from the screen). Alternatively, the user's operation may allow only any of the selected K classes to be marked. When K is a relatively large value and the K classes cannot be displayed on a single screen (i.e., the number of the classes is too large to be displayed within the screen), the user's operation may allow page feeding to see all the classes. Alternatively, a display magnification may be changeable by the user's operation. When the user selects any of the K classes, detailed information about the selected class (e.g., previously registered information) may be popped up.

In addition to the selected K classes, the unselected classes may be displayed. In this case, all of the unselected classes may be displayed, or only the classes with large classification indexes among the unselected classes (e.g., the classes with the classification indexes up to the third classification index in descending order, out of the unselected classes) may be displayed. The unselected classes may also be ranked and displayed. In addition, for the ranked K classes, a numerical value indicating the value of the classification index may be displayed. Whether or not to display the unselected classes may be switchable by the user's operation.

When the unselected classes are displayed as described above, the selected K classes and the unselected classes may be displayed in different display aspects to be distinguishable from each other. For example, the selected K classes may be displayed in a relatively prominent color (e.g., red, yellow, etc.), while the unselected K classes may be displayed in a relatively non-pronounced colors (e.g., black, brown, etc.). Furthermore, only the selected K classes may be displayed flashing, while the unselected classes may be displayed without flashing. In addition, the selected K classes may be displayed with large font or bold characters, while the unselected classes may be displayed with small font or thin characters.

### (Technical Effect)

Next, a technical effect obtained by the information processing apparatus 10 according to the seventh example embodiment will be described.

As described in FIG. 13 and FIG. 14, in the information processing apparatus 10 according to the seventh example embodiment, the selected K classes are ranked and then outputted. In this way, it is possible to easily grasp how high the possibility that the serial data belong to the class is, from the output result.

### Eighth Example Embodiment

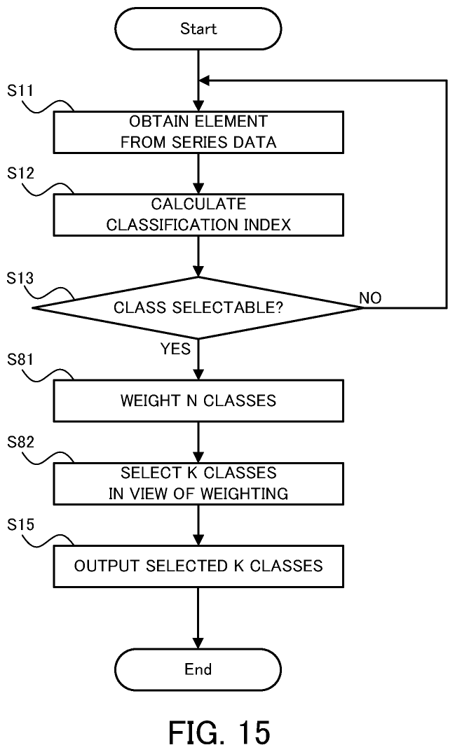

The information processing apparatus 10 according to an eighth example embodiment will be described with reference to FIG. 15. The eighth example embodiment is partially different from the first to seventh example embodiments in the operation, and may be the same as the first to seventh example embodiments in the other operation and apparatus configuration. For this reason, a part that is different from the first to seventh example embodiments will be described in detail below, and a description of other overlapping parts will be omitted as appropriate.

### (Flow of Operation)

First, with reference to FIG. 15, a flow of operation of the information processing apparatus 10 according to the eighth example embodiment will be described. FIG. 15 is a flowchart illustrating the flow of the operation of the information processing apparatus according to the eighth example embodiment. In FIG. 15, the same steps as those illustrated in FIG. 3 carry the same reference numerals.

As illustrated in FIG. 15, when the operation of the information processing apparatus 10 according to the eighth example embodiment is started, first, the acquisition unit 50 obtains one element from the series data (step S11). The acquisition unit 50 outputs the obtained element of the series data to the index calculation unit 100. Then, the index calculation unit 100 calculates the classification index on the basis of the obtained two or more elements (step S12).

Subsequently, the class selection unit 200 determines whether or not the K classes (i.e., the classes to which the serial data are likely to belong) are selectable on the basis of the calculated classification index (step S13). When the class selection unit 200 determines that the K classes are not selectable on the basis of the calculated classification index (the step S13: NO), the information processing apparatus 10 restarts the process from the step S11. That is, the information processing apparatus 10 obtains a next element of the series data and newly calculates the classification index.

On the other hand, when determining that the K classes are selectable on the basis of the calculated classification index (the step S13: YES), the class selection unit 200 weights the N classes that are the classification candidates (step S81), and selects the K classes in view of the weighting (step S82). The weighting here is weighting regarding ease of selection of the class. For example, the classes that are heavily weighted among the N classes are more easily selected as the K classes, while the classes that are lightly weighted are hardly selected as the K classes. The weight may be set as appropriate, on the basis of information or the like obtained in advance for each class. The weight may be adjustable by the user.

More specifically, as in the second example embodiment, when the classification index is calculated for each of the N classes, the weighting may be performed on each of the N classification indexes. In this case, the weighting may be performed on the previously calculated classification index, or may be performed at the time of calculation of the classification index (i.e., at the time point of step S12). Alternatively, when the K classes are selected by using the threshold for the N classification indexes, the weighting may be performed on the threshold. In this case, a separate threshold is used depending on the class.

Finally, the class selection unit 200 outputs information about the selected K classes (step S15).

### (Technical Effect)

Next, a technical effect obtained by the information processing apparatus 10 according to the eighth example embodiment will be described.

As described in FIG. 15, in the information processing apparatus 10 according to the eighth example embodiment, the weighting is performed on the N classes that are the classification candidates, and the K classes are selected in view of the weight. In this way, it is possible to adjust the ease of selection of the N classes and to select the K classes more properly.

### Ninth Example Embodiment

The information processing apparatus 10 according to a ninth example embodiment will be described. The ninth example embodiment describes specific application examples of the information processing apparatus according to the first to eighth example embodiments, and may be the same as those of the first to eighth example embodiments in the system configuration and the flow of the operation. For this reason, a part that is different from the first to eighth example embodiments will be described in detail below, and a description of other overlapping parts will be omitted as appropriate.

### (Product Proposal)

The information processing apparatus 10 according to the ninth example embodiment may be used to propose a product in which the user is likely to be interested, at a shopping site on a website. Specifically, the information processing apparatus 10 may select K products (i.e., the K classes) in which the user is likely to be interested, from N products (i.e., the N classes) that are handled products, and output them to the user. In this case, an example of the serial data to be inputted is a past purchase history, browsing history, or the like.

Similarly, it may be used to propose a product and a store in a digital signage or the like. In the digital signage, the user's image may be captured by a mounted camera. In this case, the user's feeling may be estimated from the user's image to propose a store or a product in accordance with the feeling. In addition, the user's line of sight may be estimated from the user's image (i.e., the user's viewing area may be estimated) to propose a store or a product in which the user is likely to be interested. Alternatively, the user's attribute (e.g., gender, age, etc.) may be estimated from the user's image to propose a store or a product in which the user is likely to be interested. When information about the user is estimated as described above, the N classes may be weighted in accordance with the estimated information (see the eighth example embodiment).

### (Criminal Investigation)

The information processing apparatus 10 according to the ninth example embodiment may also be used for criminal investigation. For example, when a real criminal is to be found from a plurality of suspects, selecting from them only one person who is most likely the criminal may cause a big problem when the selection is wrong. In the information processing apparatus 10 according to the example embodiment, however, high-ranking K suspects who are highly possibly the criminal can be selected and outputted. Specifically, classes corresponding to the high-ranking K suspects who are highly possibly the criminal may be selected and outputted from the series data including information about each of the plurality of suspects as the element. In this way, for example, a plurality of suspects who are highly possibly the criminal may be put under criminal investigation to properly find the real criminal.

### (Radar Image Analysis)

The information processing apparatus 10 according to the ninth example embodiment may also be applied to analyze a radar image. Since most radar images are not clear by their nature, it is hard to accurately determine what is captured in the image only by machine, for example. In the information processing apparatus 10 according to the example embodiment, however, K candidates that are likely to be captured in the radar image can be selected and outputted. Therefore, it is possible to firstly output the K candidates, from which the user can make a determination. For example, if a “dog,” a “cat,” a “ship,” and a “tank” are selected as candidates for what is captured in a radar image of a port, the user can easily determine that the “ship” that is highly related to the port, is captured in the radar image.

The above-described application examples are one example, and in a situation in which it is required to select the K candidates from the N candidates, it is possible to achieve a beneficial effect by applying the information processing apparatus 10 according to the present example embodiment.

### <Supplementary Notes>

The example embodiments described above may be further described as, but not limited to, the following Supplementary Notes below.

### (Supplementary Note 1)

An information processing apparatus described in Supplementary Note 1 is an information processing apparatus including: an acquisition unit that obtains a plurality of elements included in series data; a calculation unit that calculates a classification index indicating a likelihood of a class to which the series data belong, on the basis of at least two elements of the plurality of elements; and a selection unit that selects and outputs, from N classes that are classification candidates of the series data (where N is a natural number), K classes to which the series data are likely to belong (where K is a natural number that is less than or equal to N and that is greater than or equal to 1), on the basis of the classification index.

### (Supplementary Note 2)

An information processing apparatus described in Supplementary Note 2 is the information processing apparatus described in Supplementary Note 1, wherein the calculation unit calculates the classification index for each of the N classes.

### (Supplementary Note 3)

An information processing apparatus described in Supplementary Note 3 is the information processing apparatus described in Supplementary Note 2, wherein the calculation unit calculates, as the classification index, a likelihood ratio that is a ratio between a first likelihood indicating a likelihood that the series data belong to a class and a second likelihood indicating a likelihood that the series data do not belong to a class.

### (Supplementary Note 4)

An information processing apparatus described in Supplementary Note 4 is the information processing apparatus described in Supplementary Note 2 or 3, wherein the selection unit selects the K classes in order from an earliest arrival time when the classification index reaches a predetermined threshold, on the basis of the classification index calculated for each of the N classes.

### (Supplementary Note 5)

An information processing apparatus described in Supplementary Note 5 is the information processing apparatus described in Supplementary Note 2 or 3, wherein the selection unit selects the K classes in descending order of the classification index in a predetermined time range, on the basis of the classification index calculated for each of the N classes.

### (Supplementary Note 6)

An information processing apparatus described in Supplementary Note 6 is the information processing apparatus described in any one of Supplementary Notes 1 to 5, wherein the acquisition unit sequentially obtains the plurality of elements, and the calculation unit calculates the classification index by considering continuity of the at least two elements.

### (Supplementary Note 7)

An information processing apparatus described in Supplementary Note 7 is the information processing apparatus described in any one of Supplementary Notes 1 to 6, wherein the selection unit ranks and outputs the selected K classes in descending order of a possibility that the serial data belong to the class.

### (Supplementary Note 8)

An information processing apparatus described in Supplementary Note 8 is the information processing apparatus described in any one of Supplementary Notes 1 to 7, wherein the selection unit performs weighting about ease of selection, on each of the N classes, and then selects the K classes.

### (Supplementary Note 9)

An information processing method described in Supplementary Note 9 is an information processing method including: obtaining a plurality of elements included in series data; calculating a classification index indicating a likelihood of a class to which the series data belong, on the basis of at least two elements of the plurality of elements; and selecting and outputting, from N classes that are classification candidates of the series data (where N is a natural number), K classes to which the series data are likely to belong (where K is a natural number that is less than or equal to N and that is greater than or equal to 1), on the basis of the classification index.

### (Supplementary Note 10)

A computer program according to Supplementary Note 10 is a computer program that operates a computer: to obtain a plurality of elements included in series data; to calculate a classification index indicating a likelihood of a class to which the series data belong, on the basis of at least two elements of the plurality of elements; and to select and output, from N classes that are classification candidates of the series data (where N is a natural number), K classes to which the series data are likely to belong (where K is a natural number that is less than or equal to N and that is greater than or equal to 1), on the basis of the classification index.

### (Supplementary Note 11)

A recording medium described in Supplementary Note 11 is a recording medium on which the computer program described in Supplementary Note 10 is recorded.

This disclosure is not limited to the examples described above and is allowed to be changed, if desired, without departing from the essence or spirit of this disclosure which can be read from the claims and the entire specification. An information processing apparatus, an information processing method, and a computer program with such changes are also intended to be within the technical scope of this disclosure.

### DESCRIPTION OF REFERENCE CODES

10 Information processing apparatus
11 Processor
50 Acquisition unit
100 Index calculation unit
110 First calculation unit
111 Likelihood ratio calculation unit
112 First storage unit
120 Second calculation unit
121 Integrated likelihood ratio calculation unit
122 Second storage unit
200 Class selection unit

1. An information processing apparatus comprising:
at least one memory that is configured to store instructions; and
at least one processor that is configured to execute the instructions to
obtain a plurality of elements included in series data;
calculate a classification index indicating a likelihood of a class to which the series data belong, on the basis of at least two elements of the plurality of elements; and
select and output, from N classes that are classification candidates of the series data (where N is a natural number), K classes to which the series data are likely to belong (where K is a natural number that is less than or equal to N and that is greater than or equal to 1), on the basis of the classification index.

2. The information processing apparatus according to claim 1, wherein the at least one processor is configured to execute the instructions to calculate the classification index for each of the N classes.

3. The information processing apparatus according to claim 2, wherein the at least one processor is configured to execute the instructions to calculate, as the classification index, a likelihood ratio that is a ratio between a first likelihood indicating a likelihood that the series data belong to a class and a second likelihood indicating a likelihood that the series data do not belong to a class.

4. The information processing apparatus according to claim 2, wherein the at least one processor is configured to execute the instructions to select the K classes in order from an earliest arrival time when the classification index reaches a predetermined threshold, on the basis of the classification index calculated for each of the N classes.

5. The information processing apparatus according to claim 2, wherein the at least one processor is configured to execute the instructions to select the K classes in descending order of the classification index in a predetermined time range, on the basis of the classification index calculated for each of the N classes.

6. The information processing apparatus according to claim 1, wherein
the at least one processor is configured to execute the instructions to sequentially obtain the plurality of elements, and
the at least one processor is configured to execute the instructions to calculate the classification index by considering continuity of the at least two elements.

7. The information processing apparatus according to claim 1, wherein the at least one processor is configured to execute the instructions to rank and output the selected K classes in descending order of a possibility that the serial data belong to the class.

8. The information processing apparatus according to claim 1, wherein the at least one processor is configured to execute the instructions to perform weighting about ease of selection, on each of the N classes, and then selects the K classes.

9. An information processing method comprising:
obtaining a plurality of elements included in series data;
calculating a classification index indicating a likelihood of a class to which the series data belong, on the basis of at least two elements of the plurality of elements; and
selecting and outputting, from N classes that are classification candidates of the series data (where N is a natural number), K classes to which the series data are likely to belong (where K is a natural number that is less than or equal to N and that is greater than or equal to 1), on the basis of the classification index.

10. A non-transitory recording medium on which a computer program that allows a computer to execute an information processing method is recorded, the information processing method including:
obtaining a plurality of elements included in series data;
calculating a classification index indicating a likelihood of a class to which the series data belong, on the basis of at least two elements of the plurality of elements; and
selectin and outputting, from N classes that are classification candidates of the series data (where N is a natural number), K classes to which the series data are likely to belong (where K is a natural number that is less than or equal to N and that is greater than or equal to 1), on the basis of the classification index.
